(19) United States
(12) Patent Application Publication
(10) Pub. No.: US 2010/0319509 A1
(43) Pub. Date: Dec. 23, 2010

(54) QUICK RELEASE DEVICE FOR A CHOPPER IN A WORKBENCH SAWING MACHINE

(76) Inventor: Bor-Yann CHUANG, Taiping City (TW)

Correspondence Address: SINORICA, LLC, 2275 Research Blvd., Suite 500, ROCKVILLE, MD, 20850, US

(21) Appl. No.: 12/488,975

(22) Filed: Jun. 22, 2009

(51) Int. Cl. B23D 47/02; B27B 5/29

(52) U.S. Cl. 83/102.1; 83/446

(57) ABSTRACT

A quick release device for a chopper in a workbench sawing machine according to this invention is provided with a base on which a cover is provided. A containing room is defined between the cover and the base and then the bottom of chopper blade may pass through the room. Further, a securing part passing through the cover. In the securing part, a head is formed near the base, working with the inner side formed by the containing room to clip and fix the chopper blade. Thus, only the securing part is required for adjustment to reach the effect of quick release and combination of the chopper blade.

### BACKGROUND OF THE INVENTION

1. Field of the Invention

This invention relates to a quick release device for a chopper in a workbench sawing machine.

2. Description of the Prior Art

Generally, among protective devices in a workbench sawing machine, a protective device that is named chopper is provided behind the cutting path of a circular saw blade to keep the kerf to be open, which, during cutting, prevents the portion of a longer wood which has been cut by the circular saw blade from being deformed and thus clipping the circular saw blade to cause the wood to bounce and thus cause the industrial accident.

However, owing to different types of machining, the chopper must be replaced frequently. The conventional manners of fixing with a screw bolt makes the dismantling and installation difficult and takes much time; thus, it is apparent that improvement is necessarily made.

Consequently, because of the technical defects of described above, the applicant keeps on carving unflaggingly through wholehearted experience and research to develop the present invention, which can effectively improve the defects described above.

### SUMMARY OF THE INVENTION

In a quick release device for a chopper in a workbench sawing machine according to this invention, a nick is mainly formed at the bottom of a chopper blade and fixed onto the workbench sawing machine through a quick release device. The quick release device mainly comprises a base, a cover, and a securing part. The base is fixed onto the workbench sawing machine. The cover may cover one side fixed to the base. The two sides of the cover transversally extends towards the base to form an extensive portion, and thus a containing room is formed between the cover and the base when being combined with each other, and then the bottom of chopper blade may pass through the room. Further, a tapped hole opposite to the nick of chopper blade is formed on the cover, in which the securing unit passes through the hole. In the securing unit, a head is formed near one side of the base, working with the inner circumferential side formed by the containing room to clip and fix the chopper blade. Thus, only the securing part is required for adjustment to reach the effect of quick release and combination, the efficiency of operation being thereby increased.

### BRIEF DESCRIPTION OF THE DRAWINGS

FIG. 1 is a 3D exploded view of a preferred embodiment of this invention;

FIG. 2 is a 3D exploded view of a chopper unit according to this invention;

FIG. 3 is a 3D exploded view of a quick release device according to this invention;

FIG. 4 is a 3D view of a cover according to this invention;

FIG. 5 is a sectional view of the quick release device according to this invention, illustrating that the securing part does not work;

FIG. 6 is a sectional view of the quick release device according to this invention, illustrating that the securing part works;

FIG. 7 is a 3D exploded view of a shield according to this invention;

FIG. 8 is a partial enlarged sectional view of the shield according to this invention that is combined with the chopper blade;

FIG. 9 is a 3D exploded view of a side guard plate according to this invention;

FIG. 10 is a partial enlarged perspective view of the shield guard plate according to this invention;

FIG. 11 is a partially enlarged 3D exploded view of the shield guard plate according to this invention; and

FIG. 12 is a sectional view of the shield guard plate according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

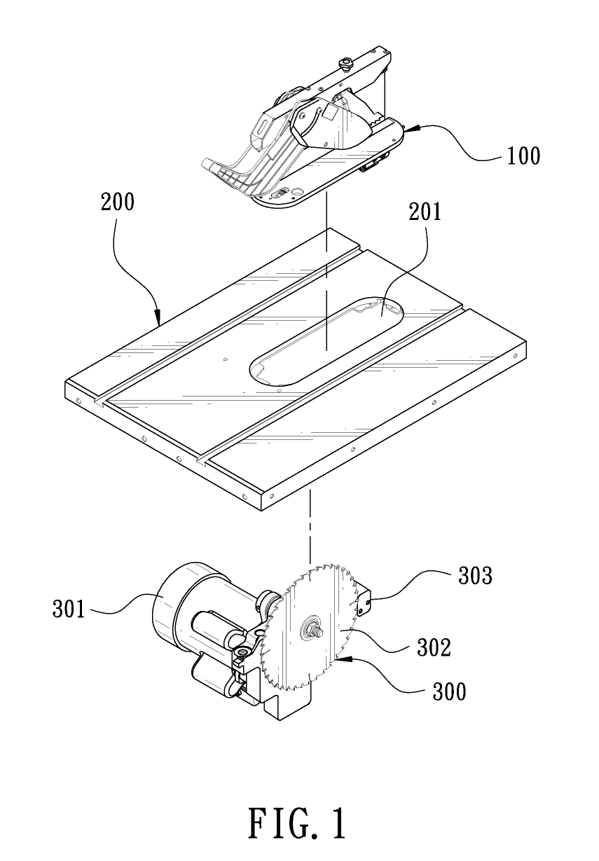

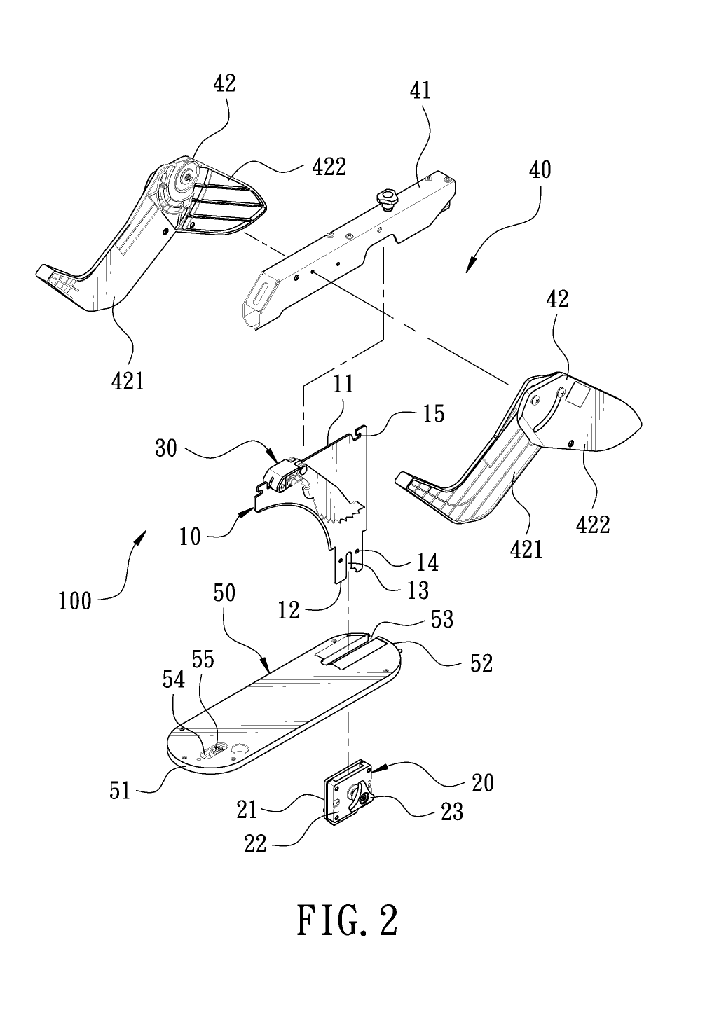

With reference to FIGS. 1 and 2 shown as 3D exploded views of a preferred embodiment of this invention and a chopper unit according to this invention, a workbench sawing machine is mainly provided with a base 300 one side of which is formed with a motor 301. A force driving side of the motor 301 is connected to a circular saw blade 302. Further, in the base 300, a fastening portion 303 is formed near the circumference of circular saw blade 302. Next, a workbench 200 is fixed onto the base 300. On the workbench 200, a long strip of thru hole 201 opposite to the circular saw blade 302 is formed, through which the circular saw blade 302 may pass, and the hole 201 is covered by a chopper unit 100. With cross-reference to FIG. 2, the chopper unit 100 mainly comprises a chopper blade 10. Two ends of the chopper blade 10 respectively define a top end 11 and a bottom end 12, in which the top end 11 is formed with a stopper gear unit 30 and a shielding unit 40, the bottom end 12 is formed with a nick 13 formed toward the top end 11 and two locating holes 14 formed separately at the left and right sides of the nick 13 and may be fixed onto the base 300 through a quick release device 20. Further, a shield 50 covers the thru hole 201 formed on the workbench 200.

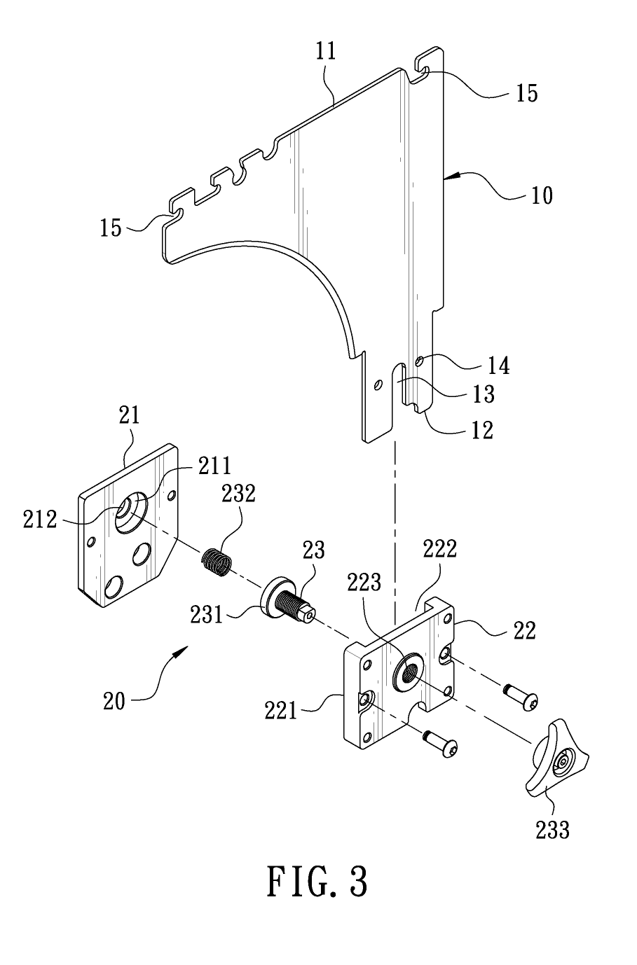

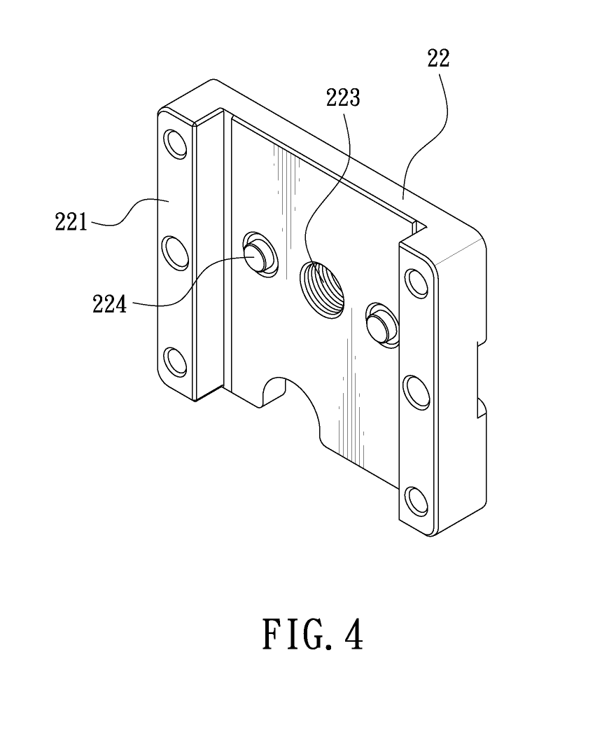

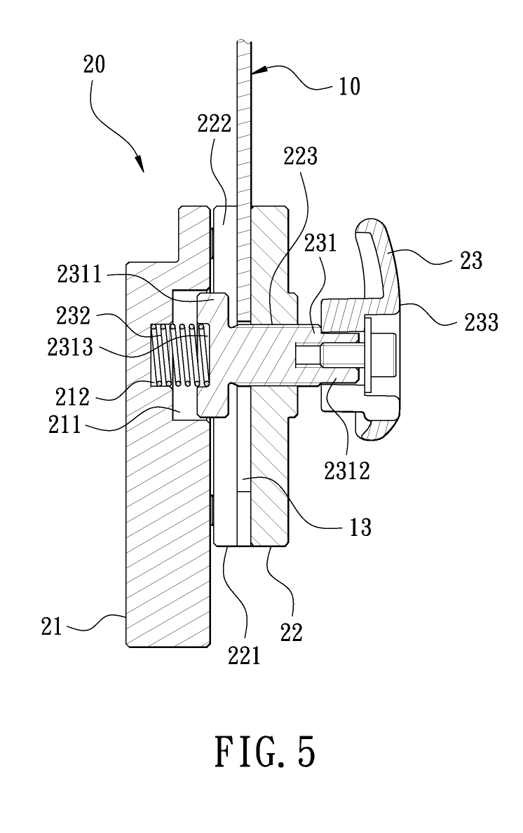

With reference to FIG. 3 shown as a 3D exploded view of the quick release device according to this invention, the quick release device 20 mainly comprises a base 21, a cover 22, and a securing unit 23. The base 21 may be fixed onto the fastening portion 303 of the base 300 as shown in FIG. 1. On the base 21, a groove 211 opposite to the nick 13 of chopper blade 10 is formed and a first slot 212 is formed at the bottom side formed by the groove 211. The cover 22 may cover the base 21. The two sides of the cover 22 transversally extends towards the base 21 to form an extensive portion 221, and thus a containing room 222 is formed between the cover 22 and the base 21 when being combined with each other, and then the bottom 12 of chopper blade 10 may pass through the room 222. Further, a tapped hole 223 opposite to the nick 13 of chopper blade 10 is formed on the cover 22. Next, with cross-reference to FIG. 4, on the side of cover 22 near the base 21, a positioning block 224 opposite to the locating hole 14 of chopper blade 10 is formed. With further reference to FIG. 5, the securing unit 23 comprises a screw bolt 231, a spring 232, and a grasp portion 233. The screw bolt 231 passes into the tapped hole 223 of cover 22. The two ends of screw bolt 231 respectively define a head 2311 and an end tip 2312. The head 2311 is formed in the groove 211 of base 21. Further, at the front side of head 2311, a second slot 2313 opposite to the first slot 212 of the base 21 is formed to house the two ends of spring 232. The grasp portion 233 is formed at the end tip 2312 of screw bolt 23 for a user to easily apply a force to adjust the position of screw bolt 23.

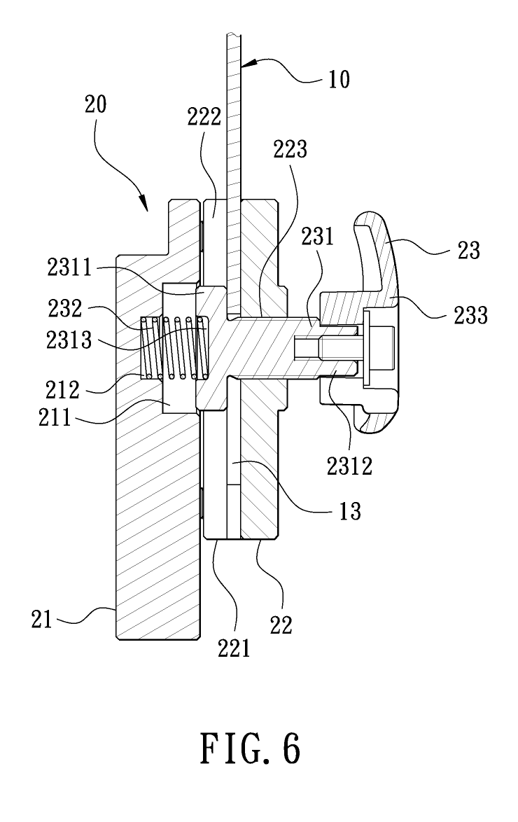

With reference to FIGS. 5 and 6 shown as sectional assembly views of the quick release device, at the time of assembly, the screw bolt 231 is first released by using the grasp portion 233 of securing part 23, making the head 2311 of screw bolt 231 move toward the groove 211 of base 21. Then, the chopper blade 10 is arranged from the top of containing room 222, the nick 13 is set across the two sides of screw bolt 231, and next the chopper blade 10 is adjusted, making the locating hole 14 of chopper blade 10 shown as FIG. 3 to be combined with the positioning block 224 of cover shown as FIG. 4 for fixing, and the screw bolt 231 is fastened. The head 2311 of screw bolt 231 and the inner side formed by the containing room 222 are used to clip and fix the chopper blade 10 for achievement of quick release of the chopper blade 10, the efficiency of operation being thereby increased. Further, the pushing force of spring 232 may prevent the screw bolt 231, when working on the workbench saw machine, from releasing.

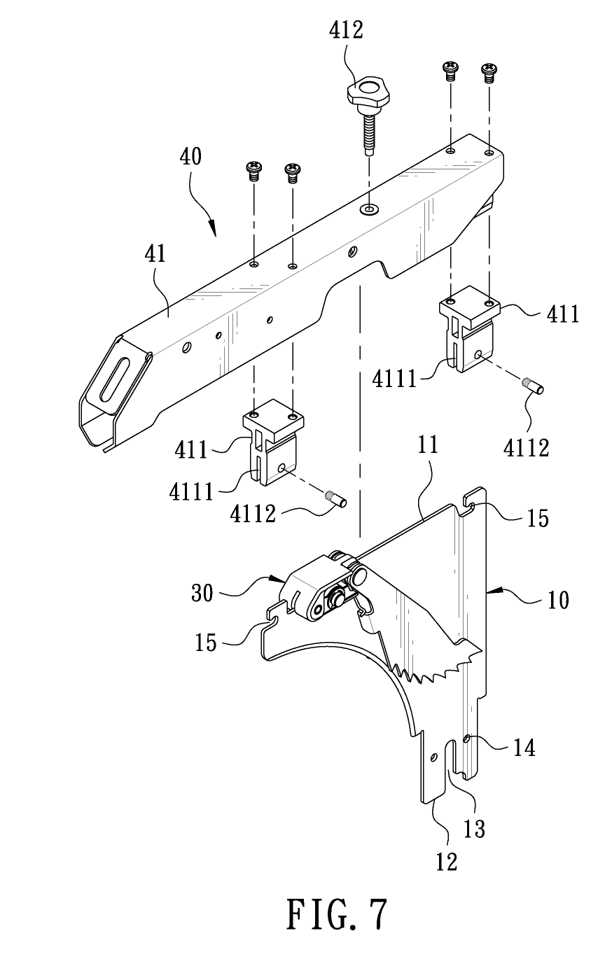

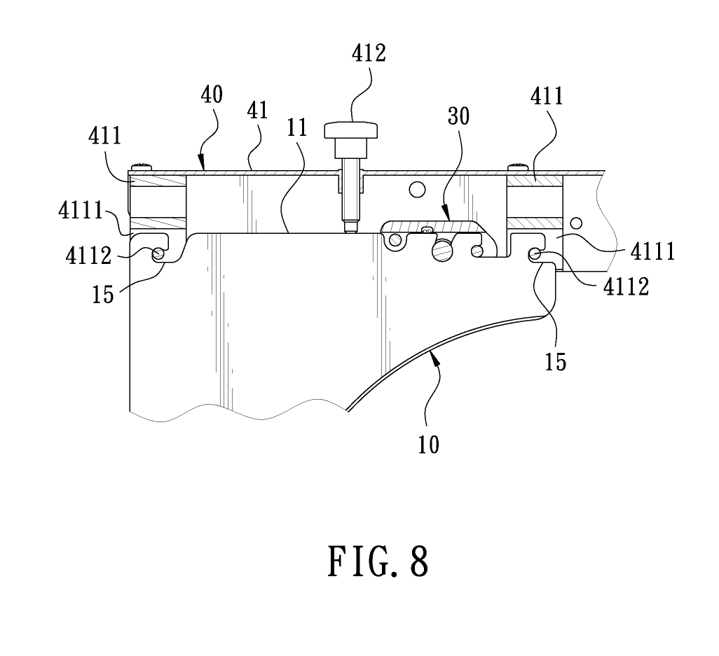

Refer to FIGS. 7 and 8 shown as a 3D exploded view and a sectional view that illustrate the cover according to this invention. First, with reference to FIG. 2, the shielding unit 40 comprises a shield 41 provided at the top of chopper blade 10, and two shielding plates 42 respectively pivoting to the two sides of shield 41. The top of chopper blade 10 is formed with two fastening grooves 15. Two fixing blocks 411 opposite to each other are arranged in the shield 41. In the fixing block 411, a chute 4111 opposite to the fastening groove 15 is formed, and a retaining rod 4112 pivots transversally into the chute 4111 to be fastened in the fastening groove 15. Further, a fastening screw bolt 412 passing through the top of shield 41. Thus, when the shield 41 is fastened to the chopper blade 10 through the fixing blocks 411 and then locks the fastening screw bolt 412, the end tip of fastening screw bolt 412 is made to stays close to the top 11 of chopper blade 10 for achievement of the effect of fixing. To remove the shield 41, only the fastening screw bolt 412 is released and reverse operation is done to remove the fixing blocks 411 from the fastening groove 15 of chopper blade 10.

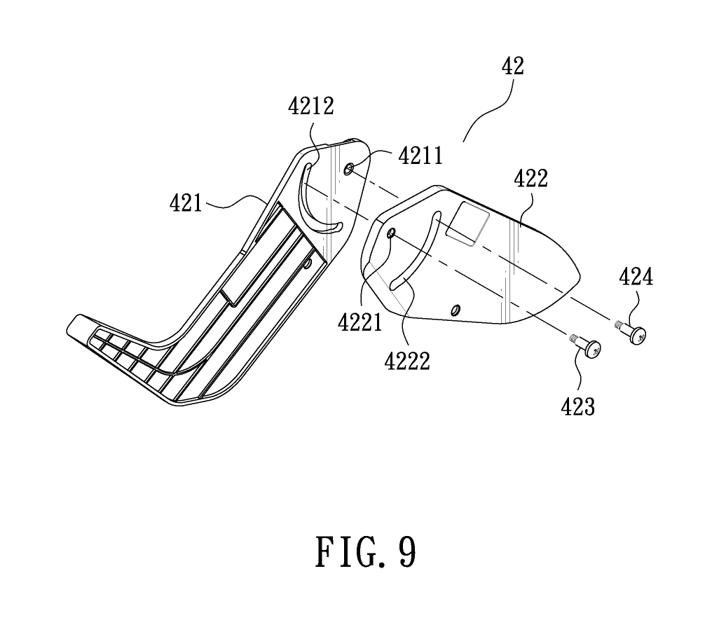

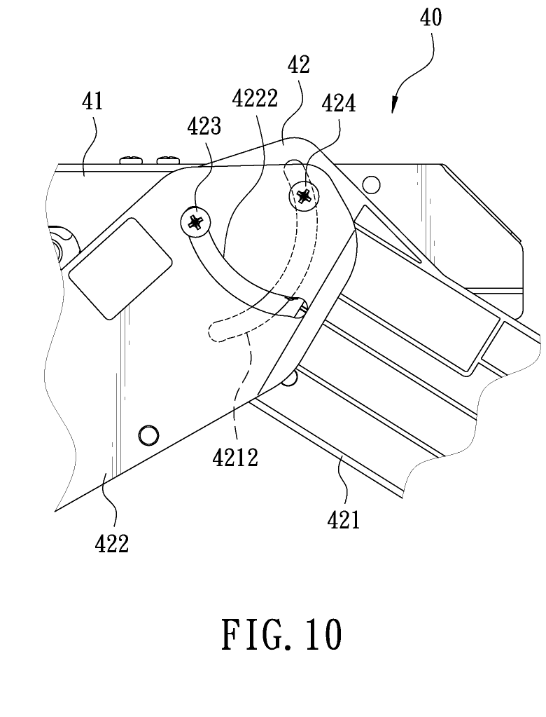

With reference to FIGS. 9 and 10 shown as a 3D exploded view and a partially enlarged perspective that illustrate the shielding plates according to this invention, the shielding plate 42 mainly comprises a first plate 421 and a second plate 422. Near one side of the shield 41, a first pivot hole 4211 is formed passing through the first plate 421, and an arc chute 4212 is formed around the first pivot hole 4211. The second plate 422 laps on the first plate 421. On the second plate 422, near one side of the first plate 421, a second pivot hole 4221 is formed. A second arc chute 4222 is formed around the second pivot hole 4221 and a first pivot rod 423 is provided passing through into the second pivot hole 4221 and the first arc chute 4212; further, a second pivot rod 424 passes through into the second arc chute 4222 and the first pivot hole 4211 so that the first plate 421 and the second plate 422 may turn around the first pivot rod 423 and the second pivot rod 424.

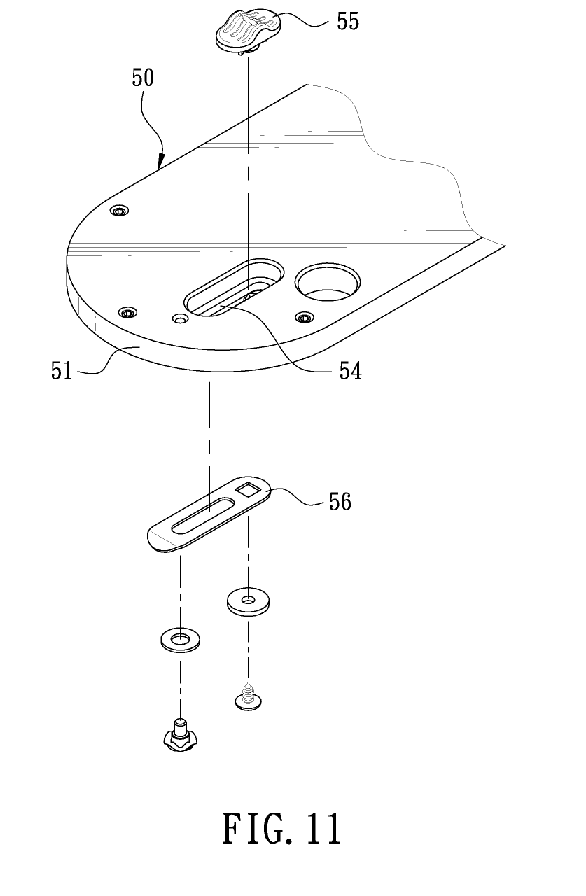

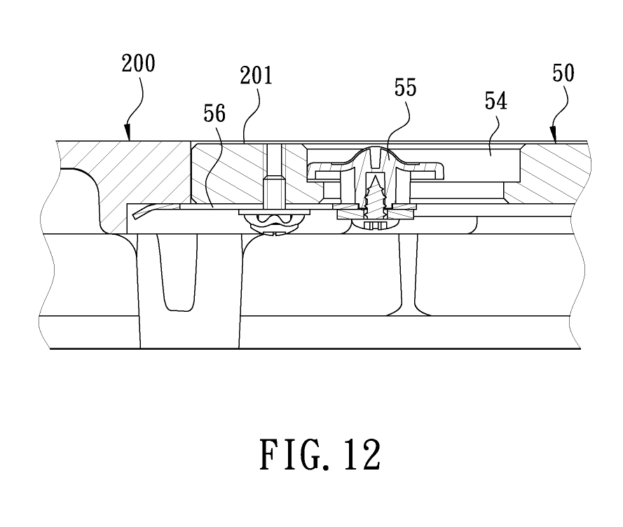

Refer to FIGS. 11 and 12 shown as a partially enlarged 3D exploded view and a partial enlarged sectional view that illustrate the shield according to this invention. With cross-reference to FIG. 2, the two sides of shield 50 respectively define a front side 51 and a rear side 52, and a nick 53 is formed at the rear side 52 to pass through the chopper blade 10. A chute 54 is formed at the front side 51. A sliding block 55 is provided in the chute 54. A wedge lamella 56 is fixed to the bottom of sliding block 55. Thus, as shown in FIG. 12, the sliding block 55 shifts forward, making the wedge lamella 56 wedge to the workbench 200 to fix the shield 50 onto the workbench 200. To remove the shield 50 from the workbench 200, it is enough to reversely operate and shift the sliding block 55 backward to make the wedge lamella 56 get away from the workbench 200.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A quick release device for a chopper in a workbench sawing machine, mainly comprising:
a chopper blade two sides of which respectively define a top end and a bottom end, at least one nick being formed towards the top end and the bottom end of chopper blade; and
a quick release device mainly comprising a base, a cover, and a securing unit, in which the base is fixed onto the workbench sawing machine, the cover covers one side fixed to the base, the two sides of the cover transversally extends towards the base to form an extensive portion, and thus a containing room is formed between the cover and the base when being combined with each other, and then the bottom of chopper blade passes through the room, a tapped hole opposite to the nick of chopper blade is formed on the cover, the securing unit passes through the tapped hole, and in the securing unit, a head is formed near one side of the base, working with the inner circumferential side formed by the containing room to clip and fix the chopper blade.

2. The quick release device for the chopper in the workbench sawing machine according to claim 1, wherein on the base of quick release device, near a side of the cover, a groove opposite to the nick of chopper blade is formed, and a first slot is formed at the bottom side formed by the groove on the base.

3. The quick release device for the chopper in the workbench sawing machine according to claim 2, wherein the securing unit of quick release device comprises a screw bolt, a spring, and a grasp portion, the screw bolt passes into the tapped hole of cover, the two ends of screw bolt respectively define a head and an end tip, the head is formed in the groove of base, at the front side of head, a second slot opposite to the first slot of the base is formed to house the two ends of spring, and the grasp portion is formed at the tip end of screw bolt.

4. The quick release device for the chopper in the workbench sawing machine according to claim 1, wherein at least one locating hole passes through the bottom of chopper blade.

5. The quick release device for the chopper in the workbench sawing machine according to claim 4, wherein a positioning block opposite to the locating hole of chopper blade 10 is formed on the cover of quick release device.

6. The quick release device for the chopper in the workbench sawing machine according to claim 1, wherein the top of chopper blade is formed with several fastening groove wedging to a shielding unit, the shielding unit comprises a shield, a fixing block opposite to the fastening groove of chopper blade is fixed into the shield, a chute near one side of the chopper blade is formed on the fixing block, a fastening rod is transversally arranged in the chute to be fastened to the fastening groove of chopper blade, a fastening screw bolt away from one side of the chopper blade is provided passing through the shield, and the end tip of fastening screw bolt stays close to the top of chopper blade.

7. The quick release device for the chopper in the workbench sawing machine according to claim 6, wherein the two sides of shield of the shielding unit further respectively pivot to a shielding plate comprising a first plate and a second plate, in which a first pivot hole is formed passing through one side of the first plate, a first arc chute is formed around the first pivot hole, the second plate laps on the first plate, one side of the second plate is formed with a second pivot hole, a second arc chute is formed around the second pivot hole, a first pivot rod is provided passing through into the second pivot hole and the first arc chute, and a second pivot rod passes through the second arc chute and the first pivot hole, and thus the first plate and the second plate turns around the first pivot rod and the second pivot rod.

8. The quick release device for the chopper in the workbench sawing machine according to claim 1, wherein a shielding cover is provided passing through the middle section of chopper blade, a chute is formed on the shield cover in which a sliding block is provided, and the bottom of sliding block is connected to a wedge lamella to wedge onto the workbench sawing machine.
